(19) United States
(12) Patent Application Publication
(10) Pub. No.: US 2025/0280379 A1
(43) Pub. Date: Sep. 4, 2025

(54) TIMING INFORMATION CONFIGURATION FOR PASSIVE IOT

(71) Applicant: QUALCOMM Incorporated, San Diego, CA (US)

(72) Inventors: Zhikun WU, Beijing (CN); Yuchul KIM, San Diego, CA (US); Yu ZHANG, San Diego, CA (US); Huilin XU, Temecula, CA (US); Ahmed ELSHAFIE, San Diego, CA (US); Linhai HE, San Diego, CA (US); Seyedkianoush HOSSEINI, San Diego, CA (US)

(21) Appl. No.: 18/857,804

(22) PCT Filed: Jun. 17, 2022
(86) PCT No.: PCT/CN2022/099382

§ 371 Date: Oct. 17, 2024

(51) Int. Cl. H04W 56/00; H04L 5/16; H04L 27/26

(52) U.S. Cl. CPC H04W 56/0045; H04L 5/16; H04L 27/26025; H04L 27/2605

(57) ABSTRACT

A wireless node (e.g., an IoT reader such as a UE or a base station) may transmit, to an IoT device (e.g., an IoT tag), and the IoT device may receive, from the wireless node, timing information. The wireless node and the IoT device may communicate via a TDD system. The timing information may be associated with communication of a response from the IoT device. The IoT device may transmit, to the wireless node, and the wireless node may receive, from the IoT device, the response based on the timing information. In some configurations, the wireless node may operate in a half duplex mode. In some configurations, the IoT device may be a passive IoT device that may transmit information based on backscatter communication.

### TECHNICAL FIELD

The present disclosure relates generally to communication systems, and more particularly, to using an Internet of Things (IoT) tag in a cellular time division duplex (TDD) wireless communication system based on timing information.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless node (e.g., an Internet of Things (IoT) reader, a base station, or a user equipment (UE)). The apparatus may transmit timing information to an IoT device. The timing information may be associated with reception of a response from the IoT device. The apparatus may receive the response from the IoT device based on the timing information.

In an aspect of the disclosure, a method, a computer-readable medium, and an apparatus are provided. The apparatus may be an IoT device (e.g., a passive IoT tag). The apparatus may receive timing information from a wireless node. The timing information may be associated with transmission of a response from the IoT device. The apparatus may transmit the response to the wireless node based on the timing information.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example scenarios in which aspects of the disclosure may be practiced.

FIG. 5 is a diagram illustrating example operations of a conventional radio frequency identification (RFID) system.

FIG. 6 is a diagram illustrating example scenarios where data loss associated with an IoT tag response may occur in a cellular TDD wireless communication system.

FIG. 7 is an example diagram illustrating resource usage associated with a half duplex UE operating as an IoT reader with the assistance of a base station according to one or more aspects.

FIG. 8 is an example diagram illustrating an example timing information indication according to one or more aspects.

FIG. 9 is an example diagram illustrating an example timing information indication according to one or more aspects.

FIG. 10 is an example diagram illustrating an example timing information indication according to one or more aspects.

FIG. 11 is a diagram illustrating example delays in communications between a reader and an IoT tag according to one or more aspects.

FIG. 12 is an example diagram illustrating example timing information indications according to one or more aspects.

FIG. 13 is a diagram illustrating time units in an example passive IoT system according to one or more aspects.

FIG. 14 is a diagram illustrating a plurality of example predefined TDD patterns according to one or more aspects.

FIG. 15 is a diagram illustrating example time division multiplexing (TDM) operations associated with an IoT tag according to one or more aspects.

FIG. 16 is a flow diagram of an example method of wireless communication according to one or more aspects.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

FIG. 21 is a diagram illustrating an example of a hardware implementation for an example network entity.

FIG. 22 is a diagram illustrating an example of a hardware implementation for an example IoT tag/device.

### DETAILED DESCRIPTION

Passive IoT devices (which may also be referred to hereinafter as zero power IoT devices) may rely on passive communication technologies such as backscatter communication. Passive IoT devices based on passive communication technologies may be associated with low power consumption and low cost.

Conventional backscatter communication-based ultra-high frequency (UHF) radio frequency identification (RFID) systems, which may work in unlicensed industrial, scientific and medical (ISM) bands, may not interoperate with cellular wireless systems (e.g., 3G, LTE, 4G, 5G NR, 6G, or future generation systems) that mainly work in licensed bands. Further, there may be interference between these two different types of systems.

For passive communication to take place, conventional passive tags may be continuously powered up by the incident radio frequency wave during communication. For example, an RFID transmitter/reader working in the ISM bands may continuously occupy resources in ISM bands. Therefore, it is possible for such a transmitter/reader to provide power continuously to a passive RFID tag. However, in a cellular TDD wireless communication system (e.g., a 5G NR TDD system), slots (e.g., uplink slots or downlink slots) may be discontinuous in the time domain. Therefore, a passive IoT tag working with a cellular TDD wireless communication system may not continuously receive power from a transmitter/reader.

Further, full duplex readers may be used in conventional RFID systems. In other words, in conventional RFID systems, the reader may transmit continuous radio signals to power up passive tags, while simultaneously receiving data backscattered from the passive tags. However, some UEs (which may operate as readers of passive IoT tags) for the cellular wireless communication system (e.g., the 5G NR system) may not support full duplex operation. Therefore, aspects may relate to enabling a half duplex UE to conduct passive IoT communication in a TDD system (e.g., a 5G NR TDD system).

According to one or more aspects, a wireless node (e.g., an IoT reader such as a UE or a base station) may transmit, to an IoT device (e.g., an IoT tag), and the IoT device may receive, from the wireless node, timing information. The timing information may be associated with communication of a response from the IoT device. The IoT device may transmit, to the wireless node, and the wireless node may receive, from the IoT device, the response based on the timing information. Accordingly, in some configurations, low power and low cost passive IoT communication may be used in a cellular TDD wireless communication system where the reader of the IoT tag may be a half duplex device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

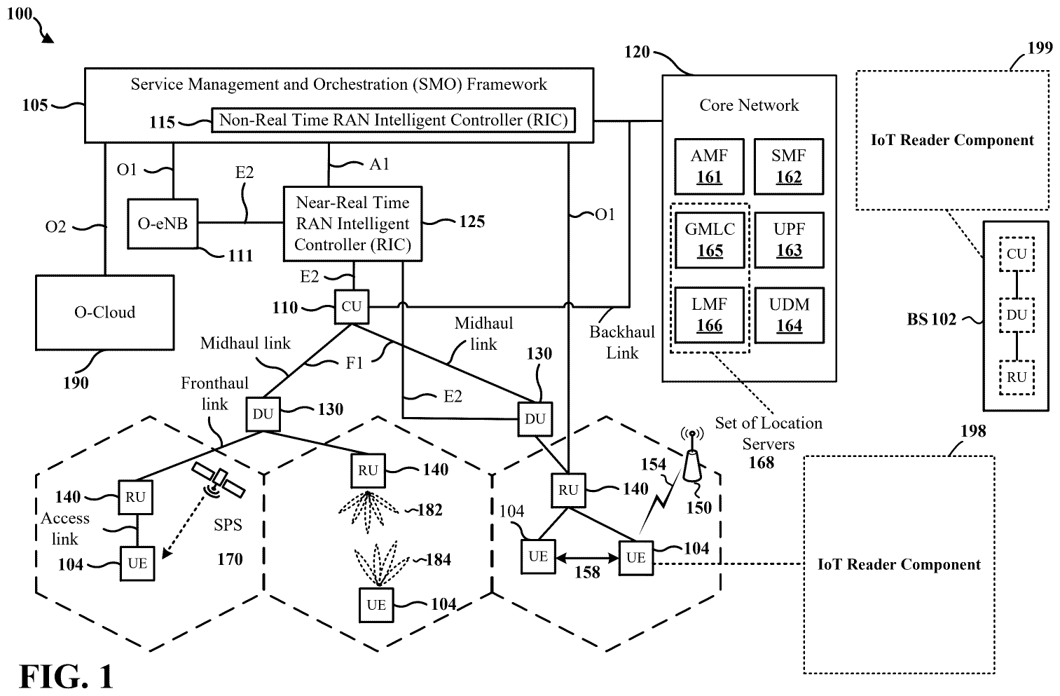

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104, operating as an IoT reader, may include an IoT reader component 198 that may be configured to transmit timing information to an IoT device. The timing information may be associated with reception of a response from the IoT device. The IoT reader component 198 may be configured to receive the response from the IoT device based on the timing information. In certain aspects, the base station 102, operating as an IoT reader, may include an IoT reader component 199 that may be configured to transmit timing information to an IoT device. The timing information may be associated with reception of a response from the IoT device. The IoT reader component 199 may be configured to receive the response from the IoT device based on the timing information. Although the following description may be focused on 5G NR, the concepts described herein may be applicable to other similar areas, such as LTE, LTE-A, CDMA, GSM, and other wireless technologies.

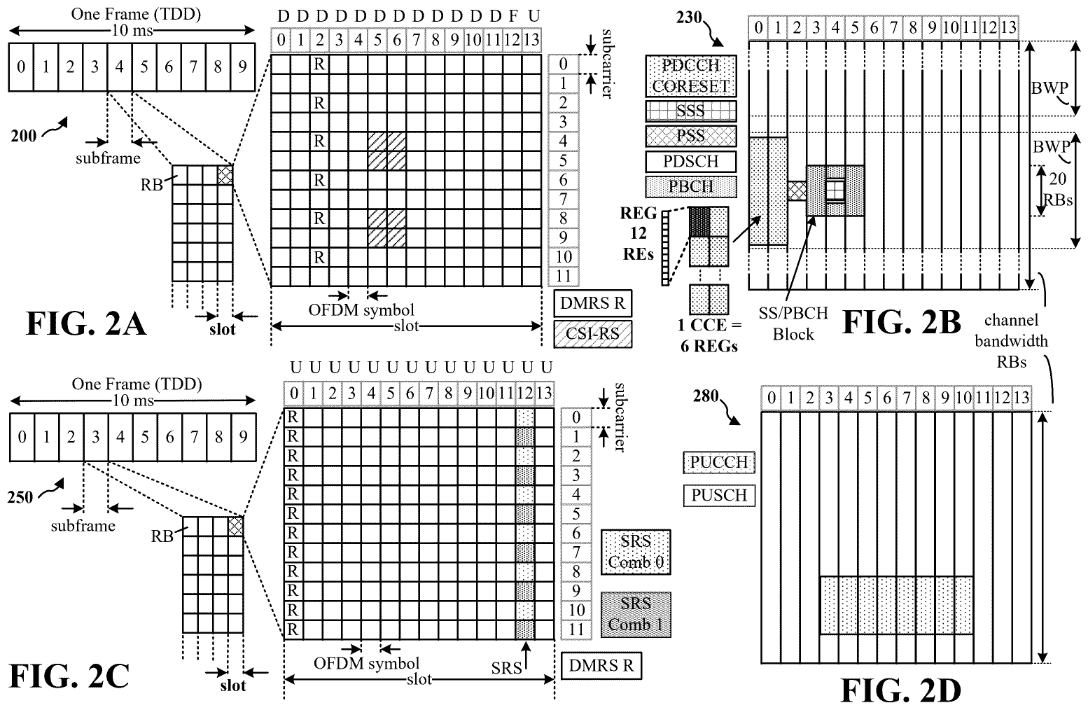

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

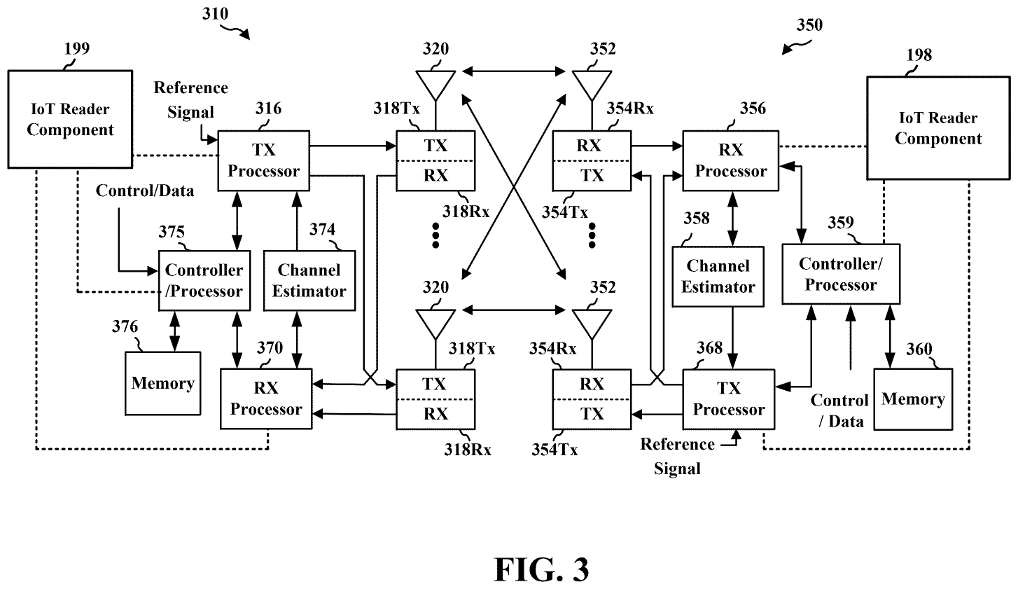

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the IoT reader component 198 of FIG. 1.

At least one of the TX processor 316, the RX processor 370, and the controller/processor 375 may be configured to perform aspects in connection with the IoT reader component 199 of FIG. 1.

Passive IoT devices may rely on passive communication technologies such as backscatter communication. Passive IoT devices based on passive communication technologies may be associated with low power consumption and low cost.

Conventional backscatter communication-based UHF RFID systems, which may work in unlicensed ISM bands, may not interoperate with cellular wireless systems (e.g., 3G, LTE, 4G, 5G NR, 6G, or future generation systems) that mainly work in licensed bands. Further, three may be interference between these two different types of systems.

For passive communication to take place, conventional passive tags may be continuously powered up by the incident radio frequency wave during communication. For example, an RFID transmitter/reader working in the ISM bands may continuously occupy resources in ISM bands. Therefore, it is possible for such a transmitter/reader to provide power continuously to a passive RFID tag. However, in a cellular TDD wireless communication system (e.g., a 5G NR TDD system), slots (e.g., uplink slots or downlink slots) may be discontinuous in the time domain. Therefore, a passive IoT tag working with a cellular TDD wireless communication system may not continuously receive power from a transmitter/reader.

Further, full duplex readers may be used in conventional RFID systems. In other words, in conventional RFID systems, the reader may transmit continuous radio signals to power up passive tags, while simultaneously receiving data backscattered from the passive tags. However, some UEs (which may be used as readers of passive IoT tags) for the cellular wireless communication system (e.g., the 5G NR system) may not support full duplex operation. Therefore, aspects may relate to enabling a half duplex UE to conduct passive IoT communication in a TDD system (e.g., a 5G NR TDD system).

Although some aspects may be described in relation to passive IoT tags, the disclosure is not so limited. Different types of IoT tags may be used with different aspects as appropriate. For example, IoT tags herein may include passive IoT tags, semi-passive IoT tags, semi-active IoT tags, or active IoT tags. In particular, a passive IoT tag may be a lightweight IoT device without a battery. The passive IoT tag may capture power from incident radio waves. The passive IoT tag may communicate with the reader in RF via backscatter communication. Specifically, a passive IoT tag may perform envelope decoding for the reception operation, and may perform backscatter communication for the transmission operation.

A semi-passive IoT tag may be similar to a passive IoT tag in that the semi-passive IoT tag may also be a lightweight IoT device that may communicate with the reader in RF via backscatter communication. However, unlike a passive IoT tag, the semi-passive IoT tag may derive power from a battery (which may be rechargeable) or energy harvest and storage circuits.

A semi-active IoT tag may be a lightweight IoT device that may communicate with the reader in RF via either backscatter communication or active transmissions. The semi-active IoT tag may be powered by a battery. As for the active IoT tag, an active IoT tag may be powered by a battery, and may communicate with the reader in RF using active transmissions.

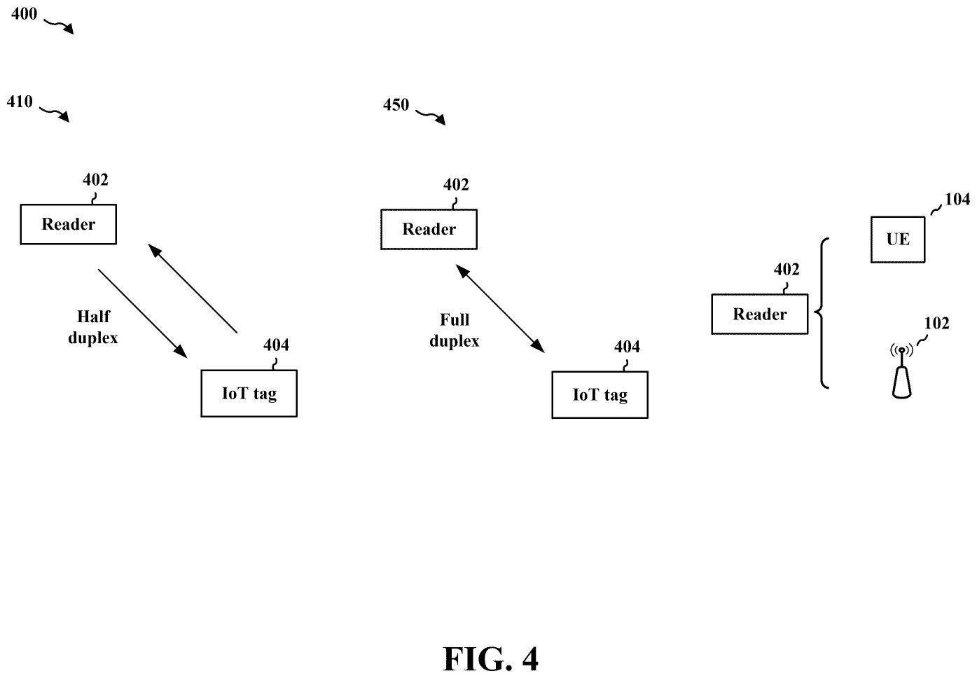

FIG. 4 is a diagram 400 illustrating example scenarios in which aspects of the disclosure may be practiced. A reader 402 may communicate with an IoT tag 404 in a cellular TDD wireless communication system (e.g., a 3G, LTE, 4G, 5G NR, 6G, or future generation TDD system). In some configurations, the reader 402 may communicate with the IoT tag 404 in licensed bands. The reader 402 may be a UE (e.g., a UE 104 in FIG. 1) or a base station (e.g., a base station 102 in FIG. 1). In other configurations, the reader 402 may also be another type of device.

The diagram 410 illustrates an example scenario in which the reader 402 may communicate with the IoT tag 404 in a half duplex mode. In other words, at any one time, the reader 402 may either transmit to the IoT tag 404 or receive from the IoT tag 404, but may not transmit to and receive from the IoT tag 404 at the same time. In contrast, the diagram 450 illustrates an example scenario in which the reader 402 may communicate with the IoT tag 404 in a full duplex mode. In other words, in the diagram 450, the reader 402 may transmit to and receive from the IoT tag 404 at the same time (using either same frequency resources or different frequency resources).

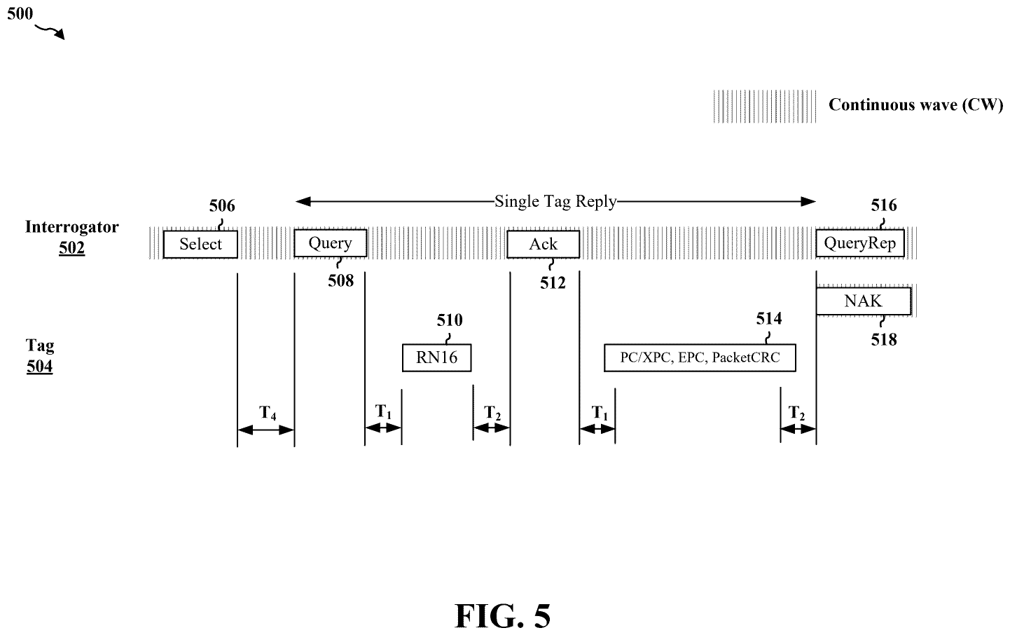

FIG. 5 is a diagram 500 illustrating example operations of a conventional RFID system. As shown, the interrogator 502 may transmit a continuous wave signal to power up a passive or semi-passive IoT tag 504. The interrogator 502 may transmit a select command 506. Upon receiving an appropriate select command 506, the IoT tag 504 may reply on further commands from the interrogator 502. The interrogator 502 may then transmit a query command 508 to instruct the selected IoT tag 504 to respond with a 16-bit random or pseudo-random number (RN16) 510. If the RN16 510 is valid, the interrogator 502 may transmit an acknowledgement (Ack) 512. Upon reception of the Ack 512 from the interrogator 502, the IoT tag 504 may transmit a packet 514 including a protocol control (PC) or an extended PC (XPC) value, an electronic product code (EPC), and a cyclic redundancy check (CRC) value (PacketCRC). The interrogator 502 may verify based on the CRC value whether or not the response packet 514 is successfully received. If the packet 514 including the EPC is successfully received, the interrogator 502 may transmit a further command (e.g., a next query command, a QueryRep command 516). If the packet 514 including the EPC is not successfully received, the interrogator 502 may transmit a non-acknowledgement (NAK) 518 to indicate to the IoT tag 504 that the previous response packet 514 is not successfully received.

Upper bounds and lower bounds for various time gaps may be defined for the conventional RFID system. These time gaps may include the time gap T₁ between the query command 508 and the RN16 510 or between the Ack 512 and the response packet 514, the time gap T₂ between the RN16 510 and the Ack 512 or between the response packet 514 and the QueryRep command 516/NAK 518, the time gap T₄ between the select command 506 and the query command 508, and so on. Further, as described above, the interrogator (reader) 502 may transmit a continuous wave signal, which may mean that the interrogator (reader) 502 may continuously occupy a channel (e.g., for 0.5 s). These techniques may work well in unlicensed bands (e.g., ISM bands). However, as described above, such operations may be incompatible with a cellular TDD wireless communication system (e.g., a 5G NR TDD system) where slots may be discontinuous in the time domain.

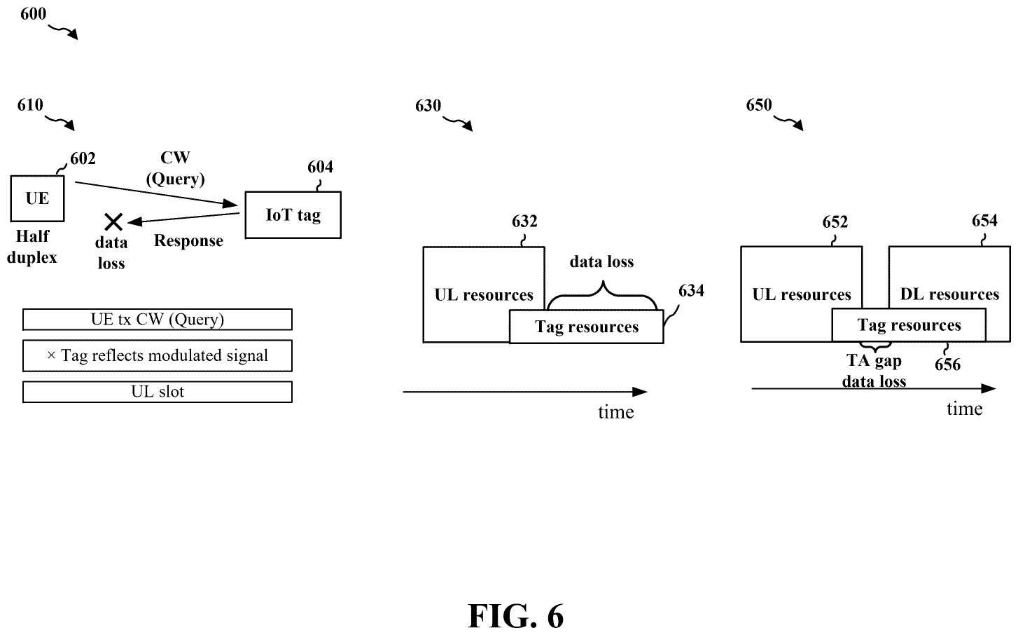

FIG. 6 is a diagram 600 illustrating example scenarios where data loss associated with an IoT tag response may occur in a cellular TDD wireless communication system. In a cellular TDD wireless communication system, the time and duration of grants or resources available for IoT transmission may differ significantly at different times (which may correspond to different slots). Data loss associated with the IoT tag response may occur if the reader and the IoT tag have no consensus about time related information (timing information). The diagram 610 illustrates an example scenario where the reader is a UE 602 operating in the half duplex mode. The UE 602 may transmit a continuous wave including a query command in an uplink slot to the IoT tag 604. Upon receiving the query command, the IoT tag 604 may immediately, within the same or a subsequent uplink slot, transmit a response (e.g., via backscatter communication by reflecting a modulated signal). However, because the response from the IoT tag 604 is transmitted in an uplink slot and the UE 602 operating in the half duplex mode may not receive any communication in an uplink slot, the data included in the response from the IoT tag 604 may be lost.

In the diagram 630, the resources 634 associated with a response from an IoT tag may extend outside the configured uplink resources 632. Accordingly, data loss may occur due to part of the response occupying resources not available for IoT transmission. Further, in the diagram 650, a time gap (e.g., 6.9 μs in duration) due to a configured timing advance (TA) may exist between the configured uplink resources 652 and the configured downlink resources 654. The resources corresponding to the time gap may not be available for IoT transmission. However, unaware of the time gap, an IoT tag may transmit a response occupying resources 656 that may partially overlap with the time gap, resulting in data loss.

In one or more configurations, a wireless node (e.g., a UE or a base station) (which may be the reader or another assisting device) may transmit timing information to an IoT tag. The timing information may include a start time, an end time, or a time window, etc. Accordingly, based on the timing information, the IoT tag may identify when it is suitable for the IoT tag to transmit. If the IoT tag transmits according to the provided timing information, data loss may be avoided.

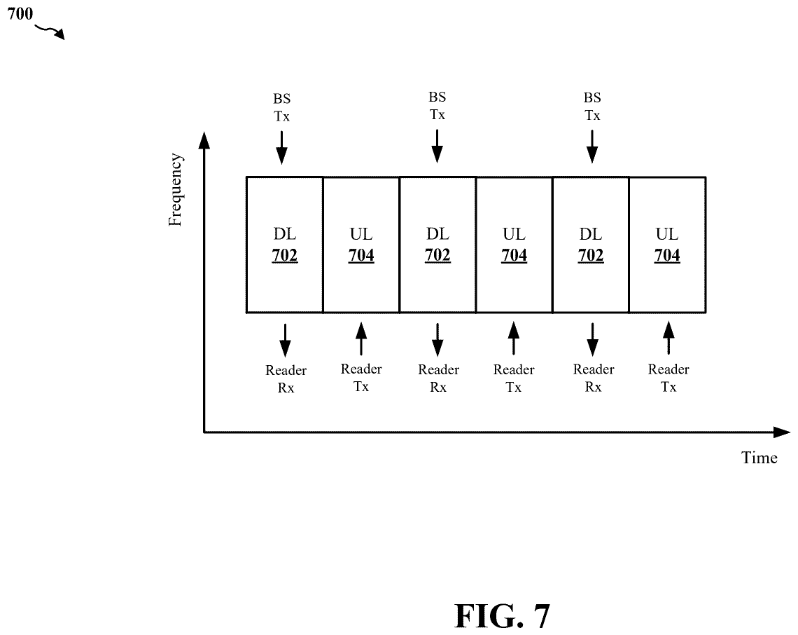

FIG. 7 is an example diagram 700 illustrating resource usage associated with a half duplex UE operating as an IoT reader with the assistance of a base station according to one or more aspects. The half duplex UE may transmit in uplink slots 704, and may receive in downlink slots 702. However, the half duplex UE may not transmit in downlink slots 702, and may not receive in uplink slots 704. Therefore, to read an IoT tag during a downlink slot 702, the half duplex UE may enlist the assistance of a base station. In a downlink slot 702, the base station may transmit a query to the IoT tag. Then, the IoT tag may respond in the same downlink slot 702. Therefore, the half duplex UE may receive the response from the IoT tag in the same downlink slot 702.

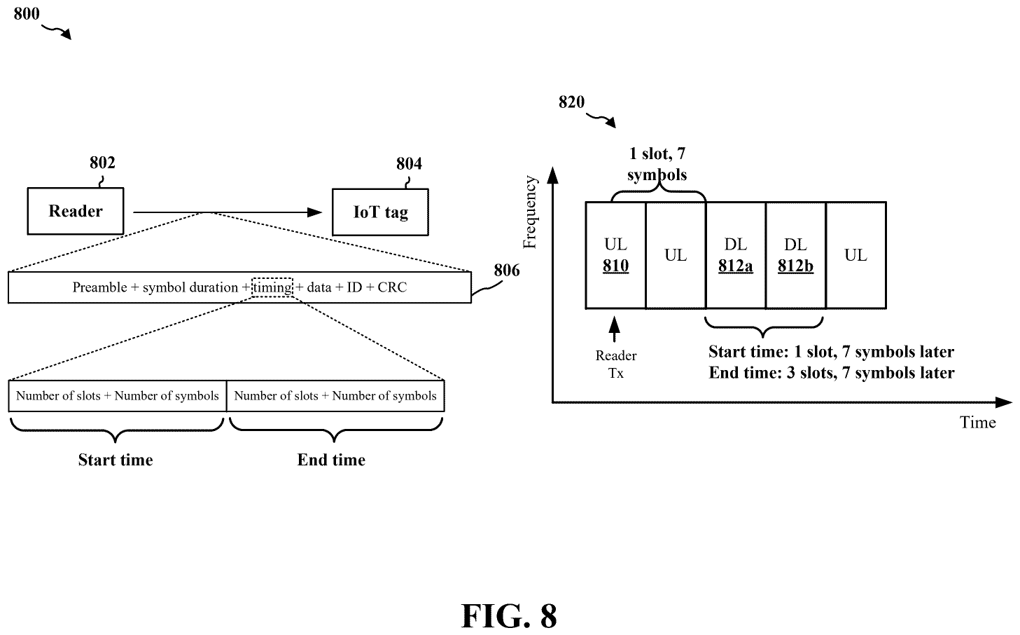

FIG. 8 is an example diagram 800 illustrating an example timing information indication according to one or more aspects. The reader 802 may be a UE operating in a half duplex mode. The reader 802 may transmit a packet 806 (e.g., a configuration packet or a query packet) to the IoT tag 804. The packet 806 may include timing information. In some configurations, the packet 806 may also include one or more of a preamble, an indication of the symbol duration, packet payload data, an identifier (ID), or a CRC value. The timing information may indicate one or more time periods suitable for the IoT tag 804 to transmit a response or other information. In some aspects, the timing information may be based on the time unit of the cellular TDD wireless communication system (e.g., the 5G NR time unit). For example, the timing information may indicate time based on a number of NR slots and/or NR symbols. In different configurations, the timing information may include a start time and an end time, or may include a start time and a duration. Further, in different configurations, the timing information may be based on a slot granularity or a symbol granularity.

As shown in the diagram 820, the reader 802 may transmit the packet 806 in the uplink slot 810 at a time that is 1 slot and 7 symbols away from the beginning of the downlink slot 812a. Because the reader 802 is a half duplex UE, the suitable time period for the IoT tag 804 to transmit may correspond to the 2 downlink slots 812a and 812b. In one example configuration, the timing information may include a start time and an end time, and may be based on the symbol granularity. Accordingly, the timing information may indicate a start time that is 1 slot and 7 symbols after the time the packet 806 is transmitted. Therefore, the start time may correspond to the beginning of the downlink slot 812a. The timing information may also indicate an end time that is 3 slots and 7 symbols after the time the packet 806 is transmitted. Therefore, the end time may correspond to the end of the downlink slot 812b.

In another example configuration, the timing information may include a start time and a duration, and may be based on the symbol granularity. Accordingly, the timing information may indicate a start time that is 1 slot and 7 symbols after the time the packet 806 is transmitted. Therefore, the start time may correspond to the beginning of the downlink slot 812a. The timing information may also indicate a duration of 2 slots, which may correspond to the 2 continuous downlink slots 812a and 812b.

In another example configuration, the timing information may include a start time and an end time, and may be based on the slot granularity. Accordingly, the timing information may indicate a start time that is 2 slots after the slot in which the packet 806 is transmitted. Therefore, the start time may correspond to the downlink slot 812a. The timing information may also indicate an end time that is 3 slots after the slot in which the packet 806 is transmitted. Therefore, the end time may correspond to the downlink slot 812b.

In yet another example configuration, the timing information may include a start time and a duration, and may be based on the slot granularity. Accordingly, the timing information may indicate a start time that is 2 slots after the slot in which the packet 806 is transmitted. Therefore, the start time may correspond to the downlink slot 812a. The timing information may also indicate a duration of 2 slots, which may correspond to the 2 continuous downlink slots 812a and 812b.

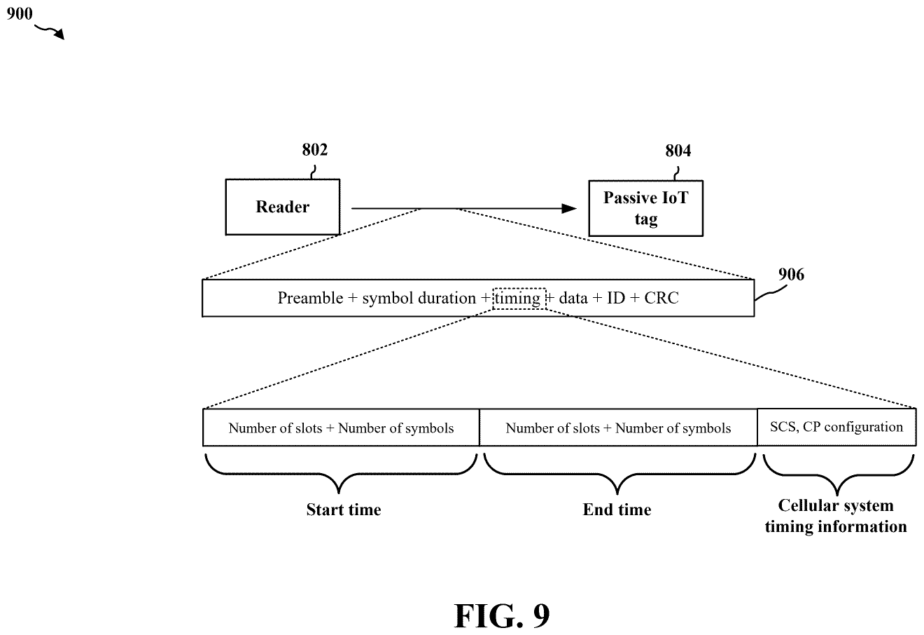

FIG. 9 is an example diagram 900 illustrating an example timing information indication according to one or more aspects. The reader 802 may be a UE operating in a half duplex mode. The reader 802 may transmit a packet 906 (e.g., a configuration packet or a query packet) to the IoT tag 804. The packet 906 may include timing information. In some configurations, the packet 906 may also include one or more of a preamble, an indication of the symbol duration, packet payload data, an ID, or a CRC value. The timing information may indicate one or more time periods suitable for the IoT tag 804 to transmit a response or other information.

In one or more configurations, because a cellular TDD wireless communication system (e.g., a 5G NR TDD system) may support different SCSs (which may correspond to different slot durations) and/or different CPs (e.g., normal CP or extended CP) (which may correspond to different symbol durations), the timing information provided by the reader 802 may also include such cellular TDD system timing information as the SCS configuration or the CP configuration. Accordingly, the timing information included in the packet 906 in FIG. 9 may differ from the timing information included in the packet 806 in FIG. 8 in that the timing information included in the packet 906 in FIG. 9 may further include the cellular TDD system timing information, which may include an indication of the SCS configuration and/or an indication of the CP configuration, or other equivalent timing information.

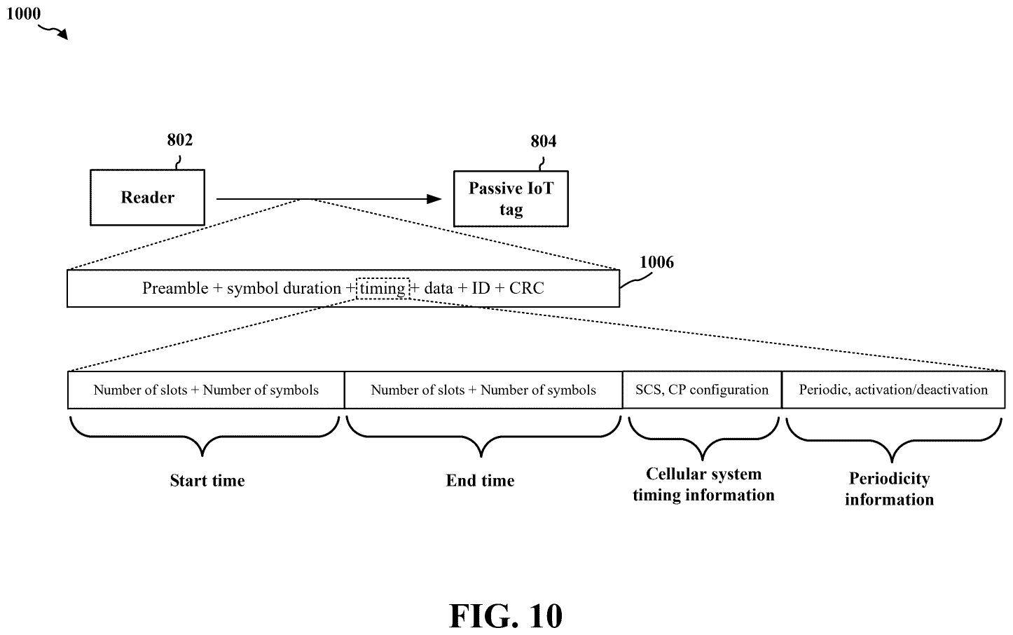

FIG. 10 is an example diagram 1000 illustrating an example timing information indication according to one or more aspects. The reader 802 may be a UE operating in a half duplex mode. The reader 802 may transmit a packet 1006 (e.g., a configuration packet or a query packet) to the IoT tag 804. The packet 1006 may include timing information. In some configurations, the packet 1006 may also include one or more of a preamble, an indication of the symbol duration, packet payload data, an ID, or a CRC value. The timing information may indicate one or more time periods suitable for the IoT tag 804 to transmit a response or other information.

In one or more configurations, the resources (including time periods) usable by the IoT tag 804 to transmit a response may be dynamically configured, persistent, or semi-persistent. Accordingly, the timing information included in the packet 1006 in FIG. 10 may differ from the timing information included in the packet 906 in FIG. 9 in that the timing information included in the packet 1006 in FIG. 10 may further include one or more of periodicity information (e.g., for persistent resources), activation/deactivation information (e.g., for dynamically configured resources), or an indication of a number of times the resource configuration may be repeated (e.g., for semi-persistent resources).

In one or more configurations, the reader 802 may include the timing information in every packet (e.g., packet 806, 906, or 1006) transmitted to the IoT tag 804. In one or more further configurations, if periodic resources are configured for the IoT tag 804 to transmit responses, and if the IoT tag 804 is capable of storing the timing information in a local storage, the reader 802 may not include the timing information in every packet transmitted to the IoT tag 804. Accordingly, after transmitting the timing information to the IoT tag 804 for the first time, the reader 802 may omit the timing information in at least some of the subsequent packets transmitted to the IoT tag 804.

In different configurations, the reader 802 may transmit the timing information to the IoT tag 804 with or without additional data (e.g., within a same packet).

In one or more configurations, the timing information provided by the reader to the IoT tag may be identified by the reader (e.g., the reader may determine the exact values associated with the timing information) based on one or more factors. For example, if the reader is a UE, the UE-reader may identify the timing information (i.e., determine the exact values associated with the timing information) based on allocated or indicated resources (e.g., uplink or downlink resources). In a further example, the UE-reader may identify the timing information (i.e., determine the exact values associated with the timing information) based on another indication (e.g., the exact values) from a base station or from another UE. If the reader is a base station, the base station-reader may identify the timing information (i.e., determine the exact values associated with the timing information) according to the implementation of the base station.

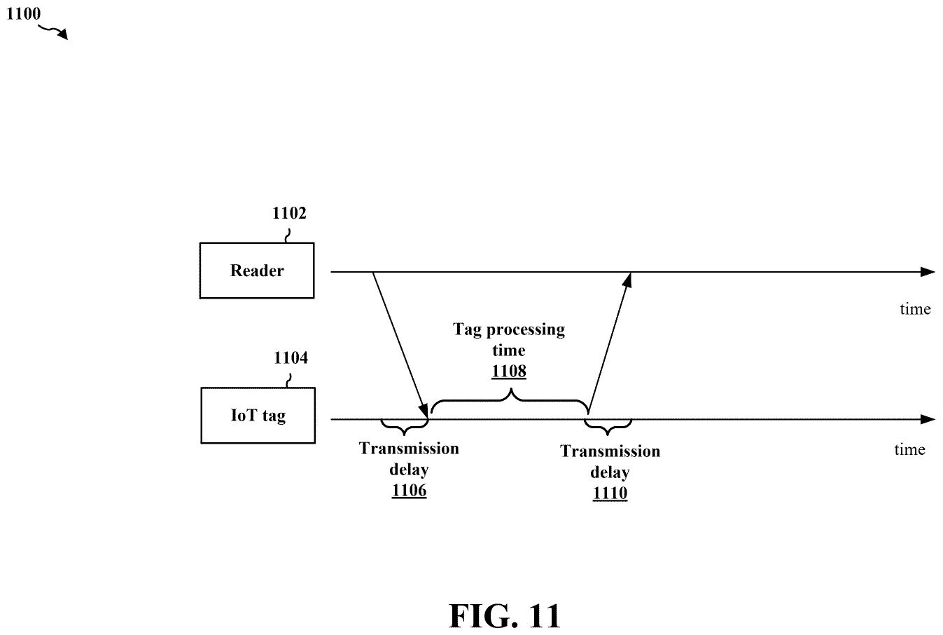

FIG. 11 is a diagram 1100 illustrating example delays in communications between a reader and an IoT tag according to one or more aspects. As shown, a transmission from the reader 1102 to the IoT tag 1104 (e.g., a query command) may be associated with a transmission delay 1106. Further, a transmission from the IoT tag 1104 to the reader 1102 (e.g., a tag response) may be associated with a transmission delay 1110. Moreover, there may be a tag processing time delay 1108 (or simply, a tag processing time 1108) between the time the IoT tag 1104 receives a command from the reader 1102 and the time the IoT tag 1104 transmits a response to the reader 1102. For example, if there is a 300 m distance between the reader 1102 and the IoT tag 1104, the transmission delays 1106/1110 may be approximately 1 μs each, and the tag processing time 1108 may be assumed to be several us.

Accordingly, the reader 1102 may identify the timing information (i.e., determine the exact values associated with the timing information) for the IoT tag 1104 based on one or more of the transmission delay 1106, the tag processing time 1108, or the transmission delay 1110. Then, the reader 1102 may transmit the timing information to the IoT tag 1104.

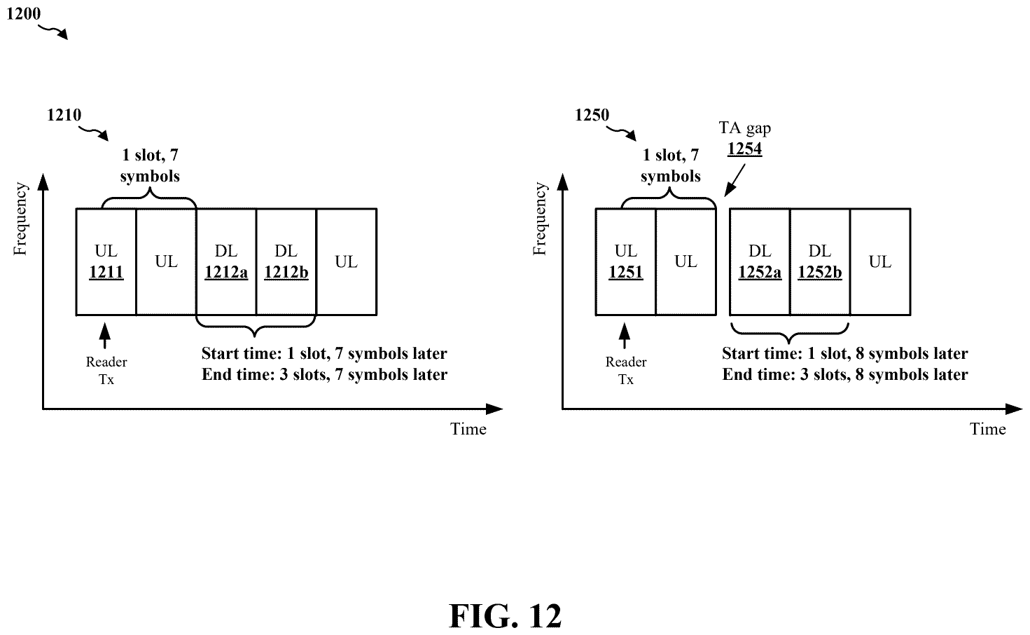

FIG. 12 is an example diagram 1200 illustrating example timing information indications according to one or more aspects. The diagram 1210 may be the same as the diagram 820 in FIG. 8. In other words, as shown in the diagram 1210, if the timing information includes a start time and an end time, and is based on the symbol granularity, the timing information may indicate a start time that is 1 slot and 7 symbols after the time the packet is transmitted by the reader to the IoT tag in the uplink slot 1211. Therefore, the start time may correspond to the beginning of the downlink slot 1212a. The timing information may also indicate an end time that is 3 slots and 7 symbols after the time the packet is transmitted by the reader to the IoT tag. Therefore, the end time may correspond to the end of the downlink slot 1212b.

In some configurations, if a UE-reader is located at or close to the cell edge (e.g., approximately 1 km from the base station), the UE-reader may follow an uplink transmission TA (e.g., configured by the base station) when transmitting in uplink slots. Further, the tag (if the tag is passive) may be powered up by some devices (e.g., a base station or another UE) other than the UE-reader. As a result, there may be a TA gap (e.g., 6.9 μs in duration, which may correspond to approximately one symbol) between the uplink resources and the downlink resources configured for the UE-reader. As shown in the diagram 1250, due to the presence of the TA gap 1254, the UE-reader may transmit, in the uplink slot 1251, the packet including the timing information to the IoT tag at a time that is 1 slot and 8 symbols (not 1 slot and 7 symbols) before the beginning of the downlink slot 1252a. Accordingly, if the TA gap 1254 is taken into consideration, and if the timing information includes a start time and an end time, and is based on the symbol granularity, the timing information may indicate a start time that is 1 slot and 8 symbols (not 1 slot and 7 symbols) after the time the packet is transmitted by the reader to the IoT tag in the uplink slot 1251. Therefore, the start time may correspond to the beginning of the downlink slot 1252a. The timing information may also indicate an end time that is 3 slots and 8 symbols (not 3 slots and 7 symbols) after the time the packet is transmitted by the reader to the IoT tag. Therefore, the end time may correspond to the end of the downlink slot 1252b.

In some configurations described above, the timing information may be based on the time units (e.g., slots, symbols) of the cellular wireless communication system (e.g., the 5G NR system). In some additional configurations, the timing information may be based on the time units associated with a passive IoT system.

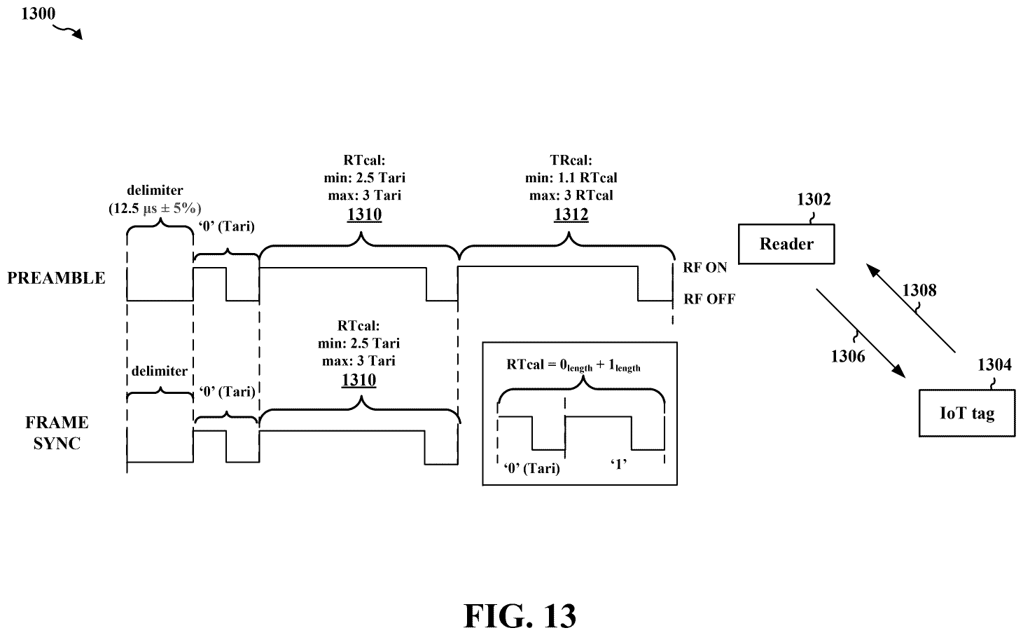

FIG. 13 is a diagram 1300 illustrating time units in an example passive IoT system according to one or more aspects. In the example passive IoT system, the link from the reader 1302 to the IoT tag 1304 may be referred to as a forward link 1306, and the link from the IoT tag 1304 to the reader 1302 may be referred to as a backscatter link 1308. The time units in the example passive IoT system may be based on a time duration Tari. Accordingly, the time units in the example passive IoT system may include the forward link symbol duration (RTcal) 1310, which may be between 2.5 Tari and 3 Tari in duration, and the backscatter link symbol duration (TRcal) 1312, which may be between 1.1 RTcal and 3 RTcal. The time units of the passive IoT system may also be referred to hereinafter as the passive IoT system time units (slots or symbols).

Therefore, in one or more example configurations, if the timing information includes a start time and an end time, the timing information may indicate a start time that is a first number of forward link symbols after the time the packet is transmitted by the reader 1302 to the IoT tag 1304. The timing information may also indicate an end time that is a second number of backscatter link symbols after the time the packet is transmitted by the reader 1302 to the IoT tag 1304.

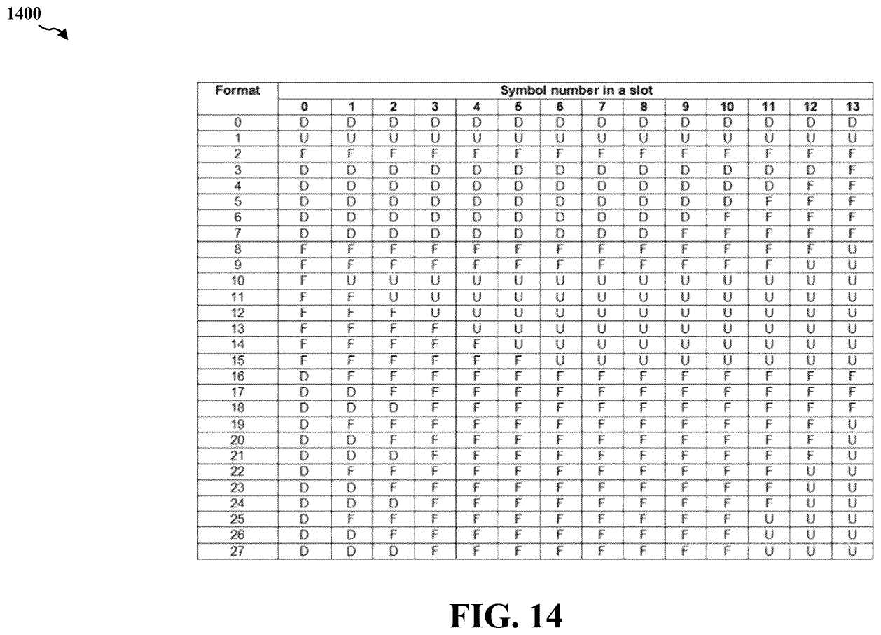

FIG. 14 is a diagram 1400 illustrating a plurality of example predefined TDD patterns according to one or more aspects. As shown, each predefined TDD pattern may include a TDD configuration (uplink (U), downlink (D), or flexible (F)) for each symbol in a slot. Further, each predefined TDD pattern may be associated with a TDD pattern index (Format #). Accordingly, in one or more configurations, several TDD patterns (TX/RX patterns) may be defined for the IoT tags, where each TDD pattern may be associated with a TDD pattern index. Based on a particular TDD pattern, an IoT tag may know the suitable time to transmit and the suitable time to receive. Therefore, in some configurations, the timing information provided by a reader to an IoT tag may include a TDD pattern index associated with a predefined TDD pattern. The IoT tag may time the transmission of the response based on the corresponding predefined TDD pattern.

In one or more configurations, if timing information is not available (e.g., if the IoT tag has not received any timing information from either the querying reader or another device) (and no other indications about the timing of the IoT response exist either), the IoT tag may respond immediately (or as soon as possible) after receiving a query or interrogation from a reader.

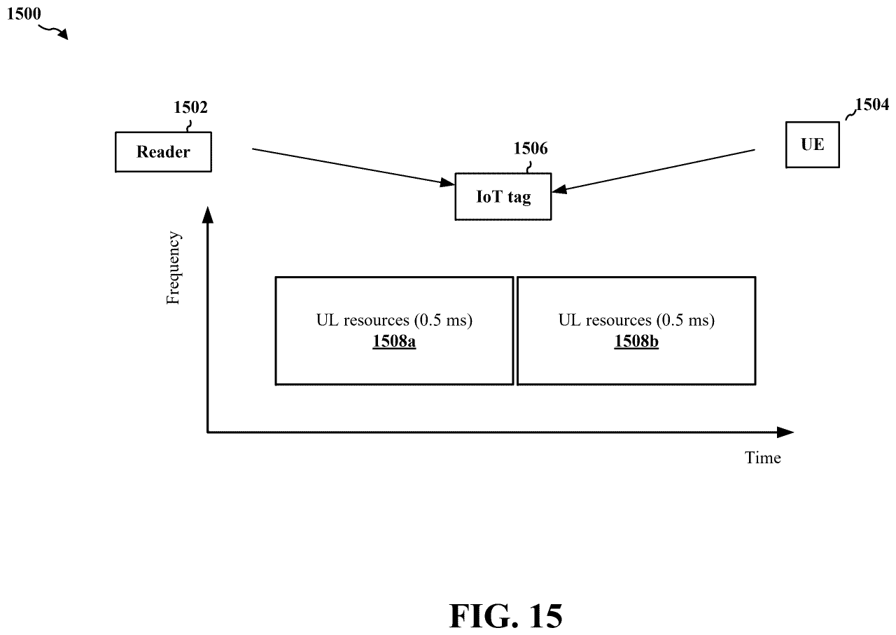

FIG. 15 is a diagram 1500 illustrating example time division multiplexing (TDM) operations associated with an IoT tag according to one or more aspects. As shown, the reader 1502 (e.g., a base station) and a UE 1504 may both transmit packets (e.g., query command packets) to the IoT tag 1506. In particular, the transmissions from the reader 1502 and the UE 1504 may be TDMed. For example, the reader 1502 may transmit to the IoT tag 1506 using the first 0.5 ms of the uplink resources 1508a, and the UE 1504 may transmit to the IoT tag 1506 using the next 0.5 ms of the uplink resources 1508b.

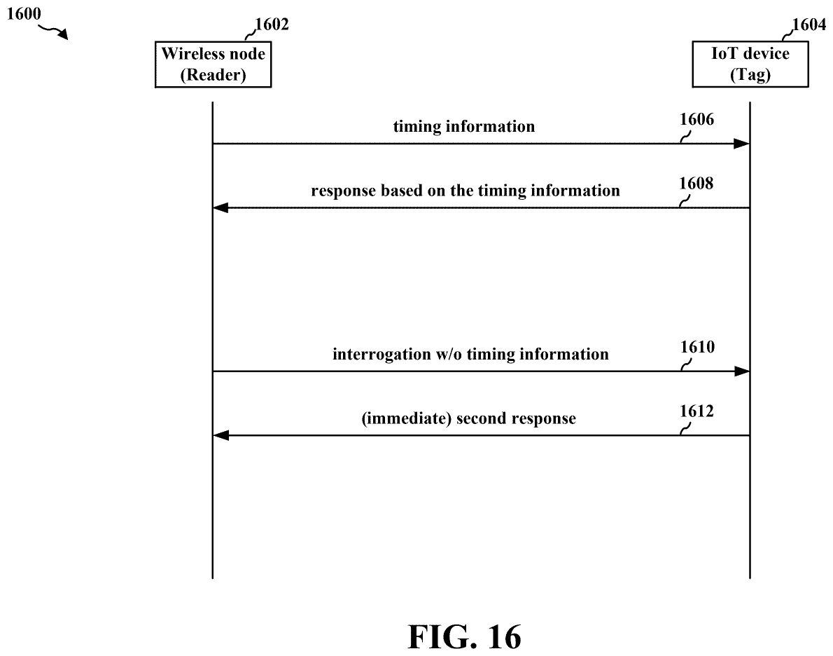

FIG. 16 is a flow diagram of an example method 1600 of wireless communication according to one or more aspects. At 1606, a wireless node 1602 (e.g., an IoT reader such as a UE or a base station) may transmit, to an IoT device 1604 (e.g., an IoT tag), and the IoT device 1604 may receive, from the wireless node 1602, timing information. The timing information may be associated with communication of a response from the IoT device 1604.

In one or more configurations, the wireless node 1602 and the IoT device 1604 may communicate via a TDD system.

At 1608, the IoT device 1604 may transmit, to the wireless node 1602, and the wireless node 1602 may receive, from the IoT device 1604, the response based on the timing information.

In one configuration, the timing information 1606 may include an indication of a start time or an indication of an end time.

In one configuration, the indication of the start time or the indication of the end time may include a number of slots or symbols.

In one configuration, the slots or the symbols may correspond to passive IoT system slots or passive IoT system symbols.

In one configuration, the timing information 1606 may include an indication of a slot duration or an indication of a symbol duration.

In one configuration, the slot duration may correspond to an SCS. The symbol duration may correspond to a normal CP or an extended CP.

In one configuration, the timing information 1606 may include at least one of periodicity information, activation information, deactivation information, or an indication of a number of repetitions (e.g., a number of times a semi-persistent resource configuration may be repeated).

In one configuration, the timing information 1606 may be associated with more than one responses from the IoT device 1604.

In one configuration, the timing information 1606 may be based on at least one of a transmission delay associated with a transmission between the wireless node 1602 and the IoT device 1604 or a processing time associated with the IoT device 1604.

In one configuration, the timing information 1606 may be based on an uplink timing advance associated with the wireless node 1602.

In one configuration, the timing information 1606 may include a transmission pattern (e.g., a TDD pattern) index. The transmission pattern index may be associated with a corresponding preconfigured transmission pattern in a plurality of preconfigured transmission patterns.

In one configuration, the wireless node 1602 may include a UE, a base station, or an IoT reader.

In one configuration, the timing information 1606 may be transmitted alone or together with additional data in a packet.

In one configuration, at 1610, the wireless node 1602 may transmit an interrogation to the IoT device 1604 without including any timing information for the IoT device 1604.

At 1612, the IoT device 1604 may transmit a second response to the wireless node 1602 immediately in response to the interrogation 1610 from the wireless node 1602 if no timing information associated with the second response 1612 is received.

In one configuration, referring to FIG. 16, the timing information 1606 may be received alone or together with additional data.

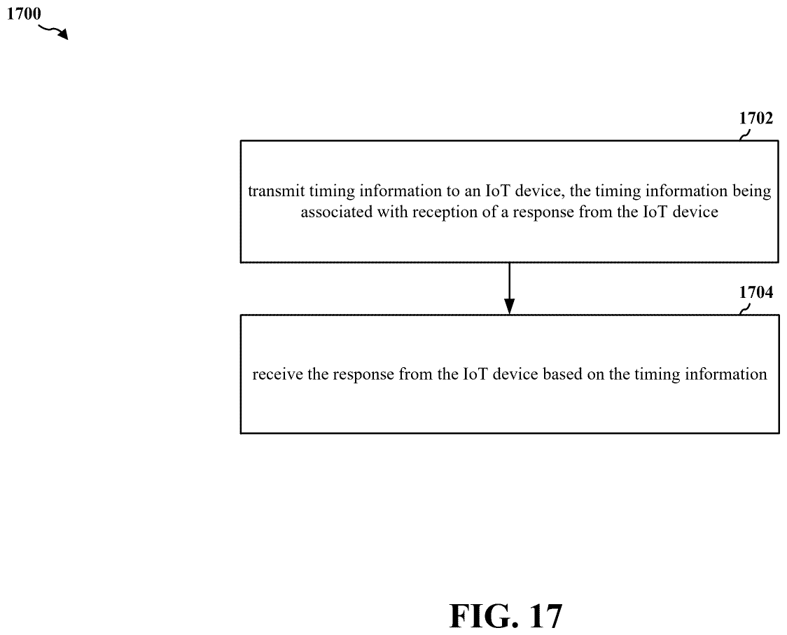

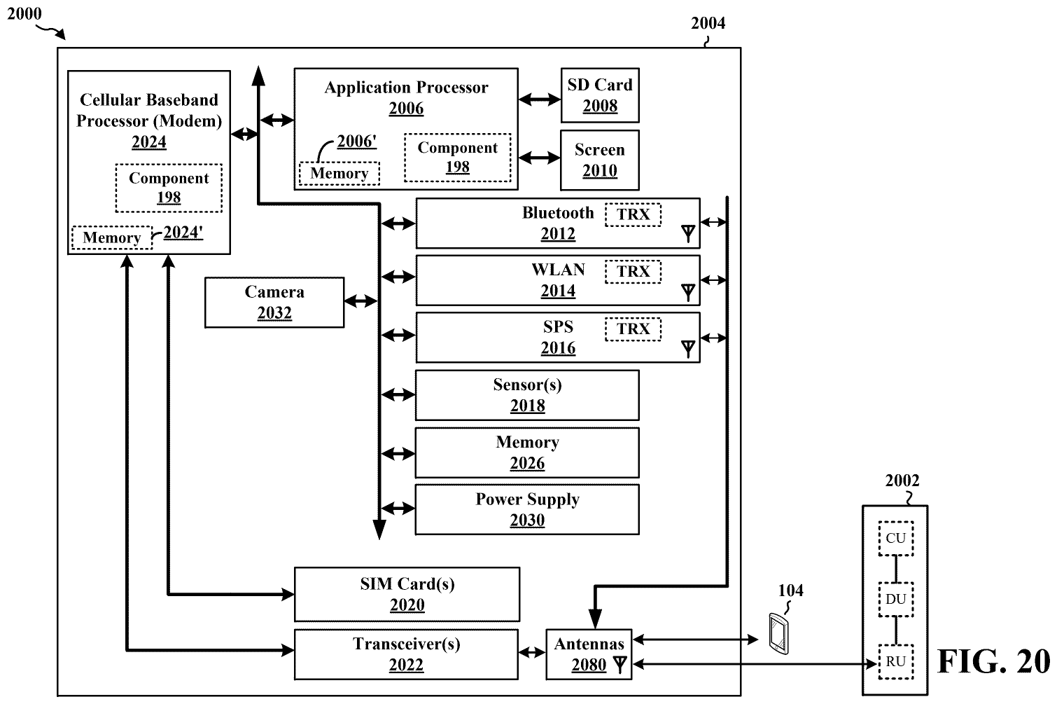

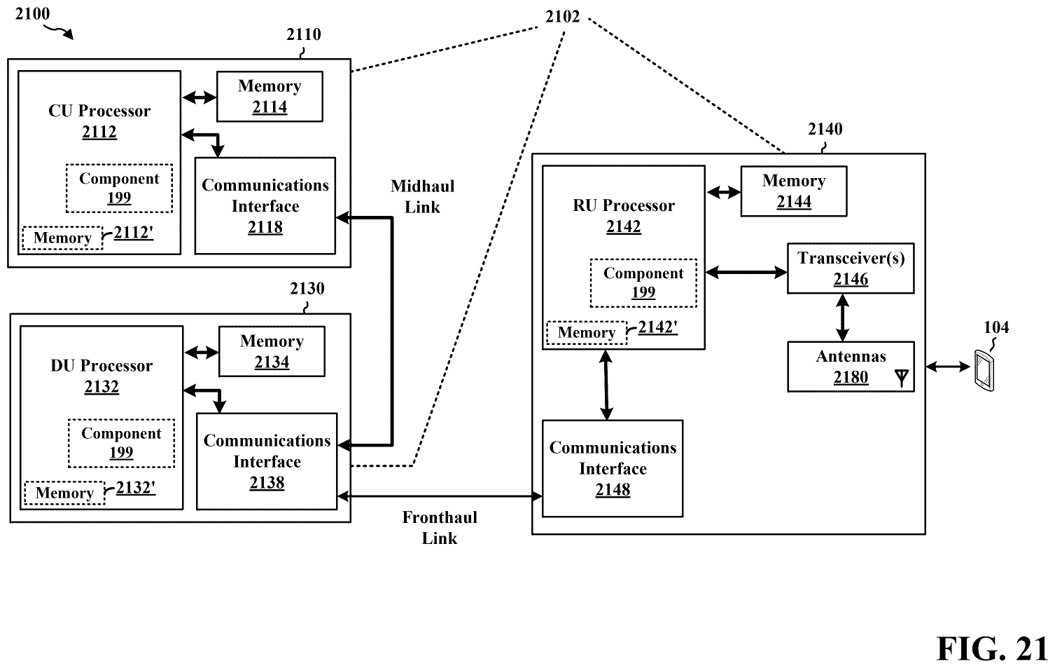

FIG. 17 is a flowchart 1700 of a method of wireless communication. The method may be performed by a wireless node (e.g., an IoT reader 402/802/1302/1502; the UE 104/350/1504; the apparatus 2004; the base station 102/310; the network entity 2002; the wireless node 1602). At 1702, the wireless node may transmit timing information to an IoT device. The timing information may be associated with reception of a response from the IoT device. For example, 1702 may be performed by the component 198 in FIG. 20 or the component 199 in FIG. 21. Referring to FIG. 16, at 1606, the wireless node 1602 may transmit timing information to an IoT device 1604.

At 1704, the wireless node may receive the response from the IoT device based on the timing information. For example, 1704 may be performed by the component 198 in FIG. 20 or the component 199 in FIG. 21. Referring to FIG. 16, at 1608, the wireless node 1602 may receive the response from the IoT device 1604 based on the timing information 1606.

In one configuration, referring to FIG. 16, the timing information 1606 may include an indication of a start time or an indication of an end time.

In one configuration, the indication of the start time or the indication of the end time may include a number of slots or symbols.

In one configuration, the slots or the symbols may correspond to passive IoT system slots or passive IoT system symbols.

In one configuration, referring to FIG. 16, the timing information 1606 may include an indication of a slot duration or an indication of a symbol duration.

In one configuration, the slot duration may correspond to an SCS. The symbol duration may correspond to a normal CP or an extended CP.

In one configuration, referring to FIG. 16, the timing information 1606 may include at least one of periodicity information, activation information, deactivation information, or an indication of a number of repetitions.

In one configuration, the timing information 1606 may be associated with more than one responses from the IoT device 1604.

In one configuration, referring to FIG. 16, the timing information 1606 may be based on at least one of a transmission delay associated with a transmission between the wireless node 1602 and the IoT device 1604 or a processing time associated with the IoT device 1604.

In one configuration, referring to FIG. 16, the timing information 1606 may be based on an uplink timing advance associated with the wireless node 1602.

In one configuration, referring to FIG. 16, the timing information 1606 may include a transmission pattern index. The transmission pattern index may be associated with a corresponding preconfigured transmission pattern in a plurality of preconfigured transmission patterns.

In one configuration, referring to FIG. 16, the wireless node 1602 may include a UE or an IoT reader.

In one configuration, referring to FIG. 16, the timing information 1606 may be transmitted alone or together with additional data.

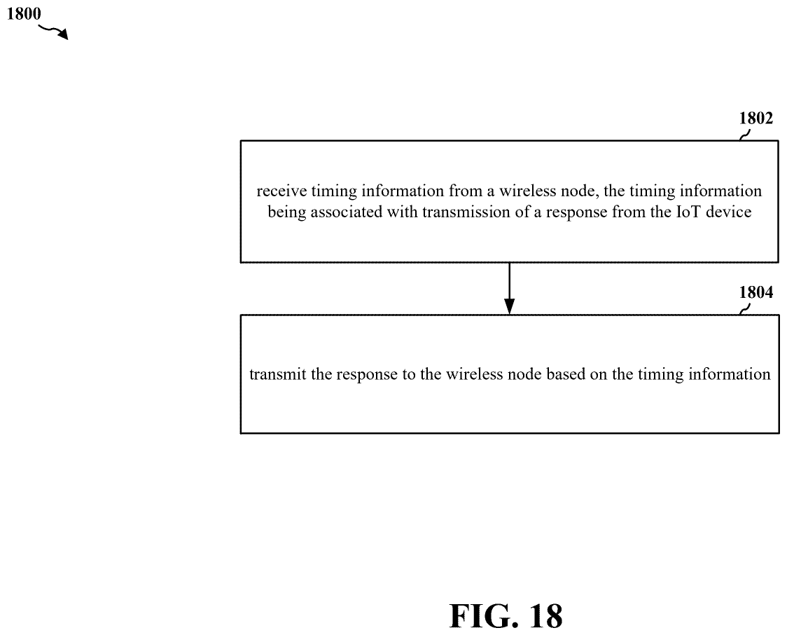

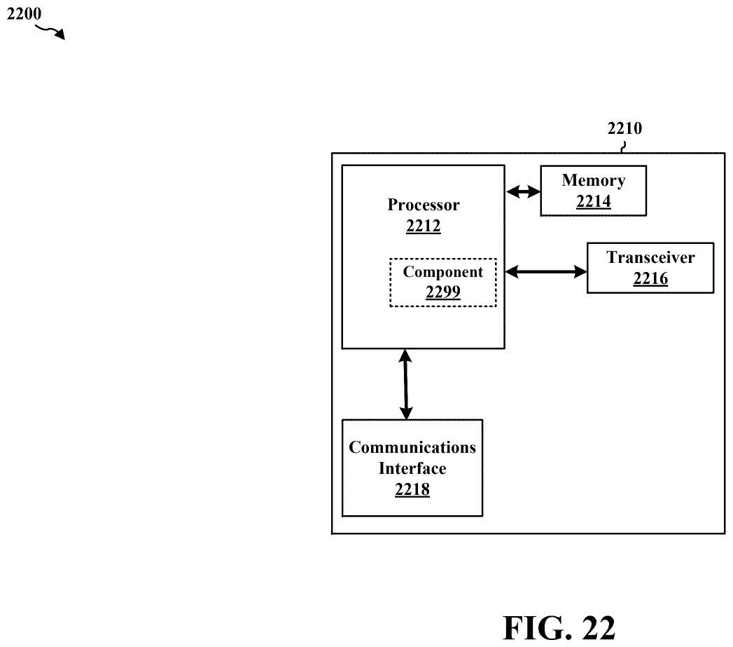

FIG. 18 is a flowchart 1800 of a method of wireless communication. The method may be performed by an IoT device (e.g., an IoT tag 404/804/1304/1506; the IoT device 1604; the IoT tag/device 2210). At 1802, the IoT device may receive timing information from a wireless node. The timing information may be associated with transmission of a response from the IoT device. For example, 1802 may be performed by the component 2299 in FIG. 22. Referring to FIG. 16, at 1606, the IoT device 1604 may receive timing information from a wireless node 1602.

At 1804, the IoT device may transmit the response to the wireless node based on the timing information. For example, 1804 may be performed by the component 2299 in FIG. 22. Referring to FIG. 16, at 1608, the IoT device 1604 may transmit the response to the wireless node 1602 based on the timing information 1606.

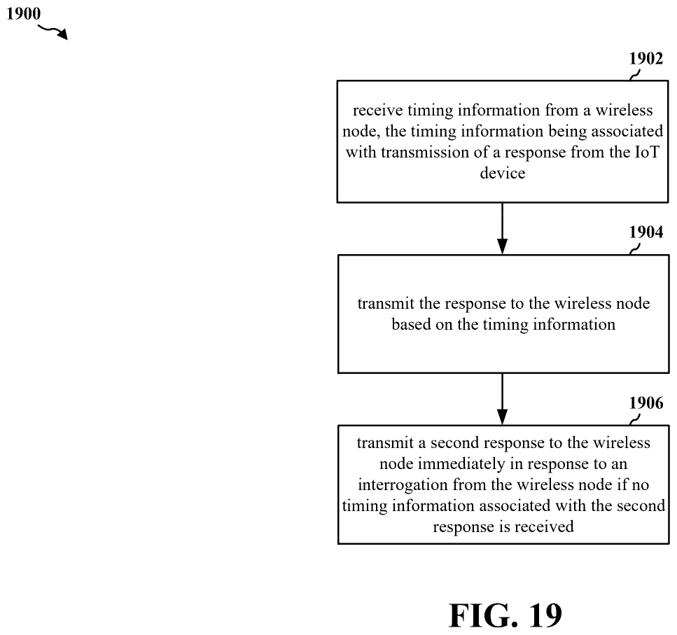

FIG. 19 is a flowchart 1900 of a method of wireless communication. The method may be performed by an IoT device (e.g., an IoT tag 404/804/1304/1506; the IoT device 1604; the IoT tag/device 2210). At 1902, the IoT device may receive timing information from a wireless node. The timing information may be associated with transmission of a response from the IoT device. For example, 1902 may be performed by the component 2299 in FIG. 22. Referring to FIG. 16, at 1606, the IoT device 1604 may receive timing information from a wireless node 1602.

At 1904, the IoT device may transmit the response to the wireless node based on the timing information. For example, 1904 may be performed by the component 2299 in FIG. 22. Referring to FIG. 16, at 1608, the IoT device 1604 may transmit the response to the wireless node 1602 based on the timing information 1606.

In one configuration, referring to FIG. 16, the timing information 1606 may include an indication of a start time or an indication of an end time.

In one configuration, the indication of the start time or the indication of the end time may include a number of slots or symbols.

In one configuration, the slots or the symbols may correspond to passive IoT system slots or passive IoT system symbols.

In one configuration, the timing information may include an indication of a slot duration or an indication of a symbol duration.

In one configuration, the slot duration may correspond to an SCS. The symbol duration may correspond to a normal CP or an extended CP.

In one configuration, referring to FIG. 16, the timing information 1606 may include

at least one of periodicity information, activation information, deactivation information, or an indication of a number of repetitions.

In one configuration, referring to FIG. 16, the timing information 1606 may be associated with more than one responses from the IoT device 1604.

In one configuration, referring to FIG. 16, the timing information 1606 may be based on at least one of a transmission delay associated with a transmission between the wireless node 1602 and the IoT device 1604 or a processing time associated with the IoT device 1604.

In one configuration, referring to FIG. 16, the timing information 1606 may be based on an uplink timing advance associated with the wireless node 1602.

In one configuration, referring to FIG. 16, the timing information 1606 may include a transmission pattern index. The transmission pattern index may be associated with a corresponding preconfigured transmission pattern in a plurality of preconfigured transmission patterns.

In one configuration, referring to FIG. 16, the wireless node 1602 may include a UE or an IoT reader.

In one configuration, at 1906, the IoT device may transmit a second response to the wireless node immediately in response to an interrogation from the wireless node if no timing information associated with the second response is received. For example, 1906 may be performed by the component 2299 in FIG. 22. Referring to FIG. 16, at 1612, the IoT device 1604 may transmit a second response to the wireless node 1602 immediately in response to an interrogation 1610 from the wireless node 1602 if no timing information associated with the second response 1612 is received.

In one configuration, referring to FIG. 16, the timing information 1606 may be received alone or together with additional data.

FIG. 20 is a diagram 2000 illustrating an example of a hardware implementation for an apparatus 2004. The apparatus 2004 may be a UE, a component of a UE, or may implement UE functionality. In some aspects, the apparatus 2004 may include a cellular baseband processor 2024 (also referred to as a modem) coupled to one or more transceivers 2022 (e.g., cellular RF transceiver). The cellular baseband processor 2024 may include on-chip memory 2024′. In some aspects, the apparatus 2004 may further include one or more subscriber identity modules (SIM) cards 2020 and an application processor 2006 coupled to a secure digital (SD) card 2008 and a screen 2010. The application processor 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor 2024 communicates through the transceiver(s) 2022 via one or more antennas 2080 with the UE 104 and/or with an RU associated with a network entity 2002. The cellular baseband processor 2024 and the application processor 2006 may each include a computer-readable medium/memory 2024′, 2006′, respectively. The additional memory modules 2026 may also be considered a computer-readable medium/memory. Each computer-readable medium/memory 2024′, 2006′, 2026 may be non-transitory. The cellular baseband processor 2024 and the application processor 2006 are each responsible for general processing, including the execution of software stored on the computer-readable medium/memory. The software, when executed by the cellular baseband processor 2024/application processor 2006, causes the cellular baseband processor 2024/application processor 2006 to perform the various functions described supra. The computer-readable medium/memory may also be used for storing data that is manipulated by the cellular baseband processor 2024/application processor 2006 when executing software. The cellular baseband processor 2024/application processor 2006 may be a component of the UE 350 and may include the memory 360 and/or at least one of the TX processor 368, the RX processor 356, and the controller/processor 359. In one configuration, the apparatus 2004 may be a processor chip (modem and/or application) and include just the cellular baseband processor 2024 and/or the application processor 2006, and in another configuration, the apparatus 2004 may be the entire UE (e.g., see 350 of FIG. 3) and include the additional modules of the apparatus 2004.

As discussed supra, the component 198 is configured to transmit timing information to an IoT device. The timing information may be associated with reception of a response from the IoT device. The component 198 may be configured to receive the response from the IoT device based on the timing information. The component 198 may be within the cellular baseband processor 2024, the application processor 2006, or both the cellular baseband processor 2024 and the application processor 2006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2004 may include a variety of components configured for various functions. In one configuration, the apparatus 2004, and in particular the cellular baseband processor 2024 and/or the application processor 2006, includes means for transmitting timing information to an IoT device. The timing information may be associated with reception of a response from the IoT device. The apparatus 2004, and in particular the cellular baseband processor 2024 and/or the application processor 2006, includes means for receiving the response from the IoT device based on the timing information.

In one configuration, the timing information may include an indication of a start time or an indication of an end time. In one configuration, the indication of the start time or the indication of the end time may include a number of slots or symbols. In one configuration, the slots or the symbols may correspond to passive IoT system slots or passive IoT system symbols. In one configuration, the timing information may include an indication of a slot duration or an indication of a symbol duration. In one configuration, the slot duration may correspond to an SCS. The symbol duration may correspond to a normal CP or an extended CP. In one configuration, the timing information may include at least one of periodicity information, activation information, deactivation information, or an indication of a number of repetitions. In one configuration, the timing information may be associated with more than one responses from the IoT device. In one configuration, the timing information may be based on at least one of a transmission delay associated with a transmission between the wireless node and the IoT device or a processing time associated with the IoT device. In one configuration, the timing information may be based on an uplink timing advance associated with the wireless node. In one configuration, the timing information may include a transmission pattern index. The transmission pattern index may be associated with a corresponding preconfigured transmission pattern in a plurality of preconfigured transmission patterns. In one configuration, the wireless node may include a UE or an IoT reader. In one configuration, the timing information may be transmitted alone or together with additional data.

The means may be the component 198 of the apparatus 2004 configured to perform the functions recited by the means. As described supra, the apparatus 2004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit timing information to an IoT device. The timing information may be associated with reception of a response from the IoT device. The component 199 may be configured to receive the response from the IoT device based on the timing information. The component 199 may be within one or more processors of one or more of the CU 2110, DU 2130, and the RU 2140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for transmitting timing information to an IoT device. The timing information may be associated with reception of a response from the IoT device. The network entity 2102 includes means for receiving the response from the IoT device based on the timing information.

In one configuration, the timing information may include an indication of a start time or an indication of an end time. In one configuration, the indication of the start time or the indication of the end time may include a number of slots or symbols. In one configuration, the slots or the symbols may correspond to passive IoT system slots or passive IoT system symbols. In one configuration, the timing information may include an indication of a slot duration or an indication of a symbol duration. In one configuration, the slot duration may correspond to an SCS. The symbol duration may correspond to a normal CP or an extended CP. In one configuration, the timing information may include at least one of periodicity information, activation information, deactivation information, or an indication of a number of repetitions. In one configuration, the timing information may be associated with more than one responses from the IoT device. In one configuration, the timing information may be based on at least one of a transmission delay associated with a transmission between the wireless node and the IoT device or a processing time associated with the IoT device. In one configuration, the timing information may be based on an uplink timing advance associated with the wireless node. In one configuration, the timing information may include a transmission pattern index. The transmission pattern index may be associated with a corresponding preconfigured transmission pattern in a plurality of preconfigured transmission patterns. In one configuration, the wireless node may include a UE or an IoT reader. In one configuration, the timing information may be transmitted alone or together with additional data.

The means may be the component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 22 is a diagram 2200 illustrating an example of a hardware implementation for an IoT tag/device 2210. The IoT tag/device 2210 may include a processor 2212. In some aspects, the IoT tag/device 2210 may further include memory modules 2214. The IoT tag/device 2210 communicates via the transceiver 2216. The IoT tag/device 2210 may further include a communications interface 2218. The memory modules 2214 may be considered a computer-readable medium/memory. Each computer-readable medium/memory may be non-transitory. The processor 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 2299 is configured to receive timing information from a wireless node. The timing information may be associated with transmission of a response from the IoT device. The component 2299 may be configured to transmit the response to the wireless node based on the timing information. The component 2299 may be within the processor 2212. The component 2299 may be one or more hardware components specifically configured to carry out the stated processes/algorithm, implemented by one or more processors configured to perform the stated processes/algorithm, stored within a computer-readable medium for implementation by one or more processors, or some combination thereof. The IoT tag/device 2210 may include a variety of components configured for various functions. In one configuration, the IoT tag/device 2210 includes means for receiving timing information from a wireless node. The timing information may be associated with transmission of a response from the IoT device. The IoT tag/device 2210 includes means for transmitting the response to the wireless node based on the timing information.

In one configuration, the timing information may include an indication of a start time or an indication of an end time. In one configuration, the indication of the start time or the indication of the end time may include a number of slots or symbols. In one configuration, the slots or the symbols may correspond to passive IoT system slots or passive IoT system symbols. In one configuration, the timing information may include an indication of a slot duration or an indication of a symbol duration. In one configuration, the slot duration may correspond to an SCS, and the symbol duration may correspond to a normal CP or an extended CP. In one configuration, the timing information may include at least one of periodicity information, activation information, deactivation information, or an indication of a number of repetitions. In one configuration, the timing information may be associated with more than one responses from the IoT device. In one configuration, the timing information may be based on at least one of a transmission delay associated with a transmission between the wireless node and the IoT device or a processing time associated with the IoT device. In one configuration, the timing information may be based on an uplink timing advance associated with the wireless node. In one configuration, the timing information may include a transmission pattern index, and the transmission pattern index may be associated with a corresponding preconfigured transmission pattern in a plurality of preconfigured transmission patterns. In one configuration, the wireless node includes a UE or an IoT reader. In one configuration, the IoT tag/device 2210 includes means for transmitting a second response to the wireless node immediately in response to an interrogation from the wireless node if no timing information associated with the second response is received. In one configuration, the timing information may be received alone or together with additional data.

The means may be the component 2299 of the IoT tag/device 2210 configured to perform the functions recited by the means.

Referring back to FIGS. 4-22, a wireless node (e.g., an IoT reader such as a UE or a base station) may transmit, to an IoT device (e.g., an IoT tag), and the IoT device may receive, from the wireless node, timing information. The timing information may be associated with communication of a response from the IoT device. The IoT device may transmit, to the wireless node, and the wireless node may receive, from the IoT device, the response based on the timing information. Accordingly, low power and low cost passive IoT communication may be used in a cellular TDD wireless communication system where the reader of the IoT tag may be a half duplex device.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless node, including transmitting timing information to an IoT device, the timing information being associated with reception of a response from the IoT device; and receiving the response from the IoT device based on the timing information.

Aspect 2 is the method of aspect 1, where the timing information includes an indication of a start time or an indication of an end time.

Aspect 3 is the method of aspect 2, where the indication of the start time or the indication of the end time includes a number of slots or symbols.

Aspect 4 is the method of aspect 3, where the slots or the symbols correspond to passive IoT system slots or passive IoT system symbols.

Aspect 5 is the method of any of aspects 1 to 4, where the timing information includes an indication of a slot duration or an indication of a symbol duration.

Aspect 6 is the method of aspect 5, where the slot duration corresponds to an SCS, and the symbol duration corresponds to a normal CP or an extended CP.

Aspect 7 is the method of any of aspects 1 to 6, where the timing information includes

at least one of periodicity information, activation information, deactivation information, or an indication of a number of repetitions.

Aspect 8 is the method of aspect 7, where the timing information is associated with more than one responses from the IoT device.

Aspect 9 is the method of any of aspects 1 to 8, where the timing information is based on at least one of a transmission delay associated with a transmission between the wireless node and the IoT device or a processing time associated with the IoT device.

Aspect 10 is the method of any of aspects 1 to 9, where the timing information is based on an uplink timing advance associated with the wireless node.

Aspect 11 is the method of any of aspects 1 to 10, where the timing information includes a transmission pattern index, and the transmission pattern index is associated with a corresponding preconfigured transmission pattern in a plurality of preconfigured transmission patterns.

Aspect 12 is the method of any of aspects 1 to 11, where the wireless node includes a UE or an IoT reader.

Aspect 13 is the method of any of aspects 1 to 12, where the timing information is transmitted alone or together with additional data.

Aspect 14 is a method of wireless communication at an IoT device, including receiving timing information from a wireless node, the timing information being associated with transmission of a response from the IoT device; and transmitting the response to the wireless node based on the timing information.

Aspect 15 is the method of aspect 14, where the timing information includes an indication of a start time or an indication of an end time.

Aspect 16 is the method of aspect 15, where the indication of the start time or the indication of the end time includes a number of slots or symbols.

Aspect 17 is the method of aspect 16, where the slots or the symbols correspond to passive IoT system slots or passive IoT system symbols.

Aspect 18 is the method of any of aspects 14 to 17, where the timing information includes an indication of a slot duration or an indication of a symbol duration.

Aspect 19 is the method of aspect 18, where the slot duration corresponds to an SCS, and the symbol duration corresponds to a normal CP or an extended CP.

Aspect 20 is the method of any of aspects 14 to 19, where the timing information includes at least one of periodicity information, activation information, deactivation information, or an indication of a number of repetitions.

Aspect 21 is the method of aspect 20, where the timing information is associated with more than one responses from the IoT device.

Aspect 22 is the method of any of aspects 14 to 21, where the timing information is based on at least one of a transmission delay associated with a transmission between the wireless node and the IoT device or a processing time associated with the IoT device.

Aspect 23 is the method of any of aspects 14 to 22, where the timing information is based on an uplink timing advance associated with the wireless node.

Aspect 24 is the method of any of aspects 14 to 23, where the timing information includes a transmission pattern index, and the transmission pattern index is associated with a corresponding preconfigured transmission pattern in a plurality of preconfigured transmission patterns.

Aspect 25 is the method of any of aspects 14 to 24, where the wireless node includes a UE or an IoT reader.

Aspect 26 is the method of aspect 14, further including: transmitting a second response to the wireless node immediately in response to an interrogation from the wireless node if no timing information associated with the second response is received.

Aspect 27 is the method of any of aspects 14 to 25, where the timing information is received alone or together with additional data.

Aspect 28 is an apparatus for wireless communication including at least one processor coupled to a memory and, based at least in part on information stored in the memory, the at least one processor is configured to implement a method as in any of aspects 1 to 27.

Aspect 29 may be combined with aspect 28 and further includes a transceiver coupled to the at least one processor.

Aspect 30 is an apparatus for wireless communication including means for implementing any of aspects 1 to 27.

Aspect 31 is a non-transitory computer-readable storage medium storing computer executable code, where the code when executed by a processor causes the processor to implement any of aspects 1 to 27.

Various aspects have been described herein. These and other aspects are within the scope of the following claims.

What is claimed is:

1. An apparatus for wireless communication at a wireless node, comprising:
a memory; and
at least one processor coupled to the memory and, based at least in part on information stored in the memory, the at least one processor is configured to:
transmit timing information to an Internet of Things (IoT) device, the timing information being associated with reception of a response from the IoT device; and
receive the response from the IoT device based on the timing information.

2. The apparatus of claim 1, wherein the timing information includes an indication of a start time or an indication of an end time.

3. The apparatus of claim 2, wherein the indication of the start time or the indication of the end time includes a number of slots or symbols.

4. The apparatus of claim 3, wherein the slots or the symbols correspond to passive IoT system slots or passive IoT system symbols.

5. The apparatus of claim 1, wherein the timing information includes an indication of a slot duration or an indication of a symbol duration.

6. The apparatus of claim 5, wherein the slot duration corresponds to a subcarrier spacing (SCS), and the symbol duration corresponds to a normal cyclic prefix (CP) or an extended CP.

7. The apparatus of claim 1, wherein the timing information includes at least one of periodicity information, activation information, deactivation information, or an indication of a number of repetitions.

8. The apparatus of claim 7, wherein the timing information is associated with more than one responses from the IoT device.

9. The apparatus of claim 1, wherein the timing information is based on at least one of a transmission delay associated with a transmission between the wireless node and the IoT device or a processing time associated with the IoT device.

10. The apparatus of claim 1, wherein the timing information is based on an uplink timing advance associated with the wireless node.

11. The apparatus of claim 1, wherein the timing information includes a transmission pattern index, and the transmission pattern index is associated with a corresponding preconfigured transmission pattern in a plurality of preconfigured transmission patterns.

12. The apparatus of claim 1, wherein the wireless node includes a user equipment (UE) or an IoT reader.

13. The apparatus of claim 1, wherein the timing information is transmitted alone or together with additional data.

14. The apparatus of claim 1, further comprising a transceiver coupled to the at least one processor.

15. A method of wireless communication at a wireless node, comprising:
transmitting timing information to an Internet of Things (IoT) device, the timing information being associated with reception of a response from the IoT device; and
receiving the response from the IoT device based on the timing information.

16. An apparatus for wireless communication at an Internet of Things (IoT) device, comprising:
a memory; and
at least one processor coupled to the memory and, based at least in part on information stored in the memory, the at least one processor is configured to:
receive timing information from a wireless node, the timing information being associated with transmission of a response from the IoT device; and
transmit the response to the wireless node based on the timing information.

17. The apparatus of claim 16, wherein the timing information includes an indication of a start time or an indication of an end time.

18. The apparatus of claim 17, wherein the indication of the start time or the indication of the end time includes a number of slots or symbols.

19. The apparatus of claim 18, wherein the slots or the symbols correspond to passive IoT system slots or passive IoT system symbols.

20. The apparatus of claim 16, wherein the timing information includes an indication of a slot duration or an indication of a symbol duration.

21. The apparatus of claim 20, wherein the slot duration corresponds to a subcarrier spacing (SCS), and the symbol duration corresponds to a normal cyclic prefix (CP) or an extended CP.

22. The apparatus of claim 16, wherein the timing information includes at least one of periodicity information, activation information, deactivation information, or an indication of a number of repetitions.

23. The apparatus of claim 22, wherein the timing information is associated with more than one responses from the IoT device.

24. The apparatus of claim 16, wherein the timing information is based on at least one of a transmission delay associated with a transmission between the wireless node and the IoT device or a processing time associated with the IoT device.

25. The apparatus of claim 16, wherein the timing information is based on an uplink timing advance associated with the wireless node.

26. The apparatus of claim 16, wherein the timing information includes a transmission pattern index, and the transmission pattern index is associated with a corresponding preconfigured transmission pattern in a plurality of preconfigured transmission patterns.

27. The apparatus of claim 16, wherein the wireless node includes a user equipment (UE) or an IoT reader.

28. The apparatus of claim 16, the at least one processor being further configured to:
transmit a second response to the wireless node immediately in response to an interrogation from the wireless node if no timing information associated with the second response is received.

29. The apparatus of claim 16, further comprising a transceiver coupled to the at least one processor, wherein the timing information is received alone or together with additional data.

30. A method of wireless communication at an Internet of Things (IoT) device, comprising:
receiving timing information from a wireless node, the timing information being associated with transmission of a response from the IoT device; and
transmitting the response to the wireless node based on the timing information.
